(19) United States
(12) Patent Application Publication
(10) Pub. No.: US 2006/0142102 A1
(43) Pub. Date: Jun. 29, 2006

(54) Pulley assembly

(76) Inventor: Mijo Radocaj, Massillon, OH (US)

Correspondence Address: PAUL E MILLIKEN, 9061 WALL STRET, NW, MASSILLON, OH, 44646-1676, US

(21) Appl. No.: 11/020,711

(22) Filed: Dec. 23, 2004

(51) Int. Cl. F16H 55/36; F16H 55/49; F16H 55/50

(52) U.S. Cl. 474/199; 474/170; 474/182

(57) ABSTRACT

A pulley assembly in which either a hub or a bearing is attached in the center of one or more pulleys either by rivets passing transversely through overlapping portions of the pulley and the hub or bearing. When fastening together a hub and a pulley, the pulley has belt groove around the outer periphery and an annual web extending radially inwardly from the belt groove. A hub has a radially outwardly extending flange which overlaps the web of the pulley and in one embodiment a plurality of rivets pass through matching holes in the pulley web and the hub flange to fasten the hub and pulley together instead of using rivets, the pulley web and hub may be fastened together either with an adhesive layer or by friction welding of adjacent surfaces of the pulley web and the hub flange. When attaching bearings to a pulley an annular flange extends radially outwardly from the outer race of the bearing and overlaps a radially inwardly extending web of a pulley. The pulley and bearing can be fastened together either by rivets passing transversely through the pulley web and bearing flange or by applying a layer of adhesive between adjacent surfaces of the pulley web and bearing flange.

### FIELD OF THE INVENTION

This invention relates generally to a pulley assembly in which a bearing or a hub is fastened in the axial center of the bearing and in particular to fastening the bearing or hub is fastened by means of a plurality of rivets or alternatively by an adhesive or by friction welding.

### BACKGROUND OF THE INVENTION

In the past is has been known to fasten two piece pulleys together on each side of a bearing to hold the bearing in place. One such example is shown in U.S. Pat. No. 4,518,372 issued to Donald D Dye.

Fastening a bearing or hub in a pulley made by splitting a disk and spin forming it into a pulley requires a different fastening configuration.

Various means have been used in the past to fasten a bearing into the center flange of a pulley or other rotary object which has been formed by splitting a circular disk and spin forming the blank into a pulley shape. A separate bearing housing is then attached to the pulley by welding staking or the like. The bearing housing is formed as two cup shaped housing which are fastened together by welding, rivets or the like to hold the bearing in place. Another means of fastening a bearing in a pulley is shown in U.S. Pat. Nos. 3,758,930 and 3,828,619 both of which are issued to Charles C Frost et al. In both these patents, a pulley is formed by typical metal splitting techniques having a central hub for receiving a bearing. The hub is formed with two axially extending annular flanges, with one being crimped radially inwardly at the same time it is formed as shown in FIG. 4 of the '930 patent to retain one side of a bearing when inserted into the hub, and the other axial flange formed extending straight axially outwardly, then later crimped around the bearing in a separate operation.

It has been found, however, that crimping each of the flanges in two separate operations does not provide as tight a fit around the bearing as when the flanges are crimped simultaneously after press fitting the bearing into the hub, since there is less area of surface contact between the hub and the bearing as shown in FIGS. 6 and 7 of the '930 patent where it can be seen that there is no surface contact between the outer circumference of the bearing except where it is crimped around the outer circumferential corners of the bearing. The angle formed by the split between the hub flanges of the '930 patent allows the flanges to bend and open up upon continued use of the bearing and hub assembly. This causes the bearing to become loose and wobbly within the hub.

In U.S. Pat. No. 5,979,203 issued to Mijo Radocaj, the present inventor has invented a machine for splitting and spin forming a disk blank into a pulley. A similar pulley can be formed for use with the present invention except the center periphery of the pulley flange would not be split In contrast to the '930 patent, in the present invention it is not necessary to split the radially inner circumferential edge of the annular web of the pulley, since the bearing or hub is not fastened within the pulley by crimping flanges of the pulley web. Instead a radially outwardly extending annular flange is provided on a bearing or hub which is overlaps the radially inwardly extending annular flange of the pulley and the overlapping flanges are securely fastened together either by rivets, an adhesive layer, or by friction welding.

### OBJECTS OF THE INVENTION

Accordingly it is an object of the present invention to provide a method and apparatus of inserting and fastening a bearing within the hub of a pulley which provides a maximum amount of surface contact between the bearing and the hub of a pulley.

Another object of the invention is to provide a method for rapidly inserting and fastening a bearing within a hub of a pulley without the need of press fitting the bearing into the hub and simultaneously crimping the axial flanges of the hub around the bearing to securely retain the bearing in the hub.

These and other objects of the invention can be readily understood by referring to the following specification and drawings.

### SUMMARY OF THE INVENTION

This invention is a pulley assembly having a pulley and a central shaft engaging member comprising: at least one pulley having an outer peripheral rim and an annular web portion extending radially inwardly therefrom; a central shaft engaging member having a radially outwardly extending annular extension the annular web portion of each pulley and the outwardly extending annular extension of the central shaft engaging member each having an annular radially extending surface in intimate contact with each other when the shaft engaging member is positioned within the center of the pulley; and a means permanently bonding the surfaces together to securely attach the shaft engaging member to the pulley.

### DESCRIPTION OF THE DRAWINGS

FIG. 1 is a side elevational view of one embodiment of a pulley assembly according to the invention with a pulley and hub fastened together by rivets;

FIG. 2 is a vertical cross sectional view taken on line 2-2 of FIG. 1;

FIG. 3 is a side elevational view of another embodiment of a pulley assembly according to the invention with a pulley and hub fastened together by an adhesive;

FIG. 4 is a vertical cross sectional view taken on line 4-4 of FIG. 3;

FIG. 5 is a fragmentary side elevational view of an apparatus for fastening together a pulley and hub by means of friction welding;

FIG. 6 is a vertical cross sectional view of a pulley assembly with a pulley and hub attached by the apparatus shown in FIG. 5;

FIG. 7 is a vertical cross sectional view of a pulley assembly with a pulley riveted to a bearing;

FIG. 8 is a vertical cross sectional view of a pulley assembly with a pair of pulleys riveted to each side of a bearing; and

FIGS. 9 through 13 are vertical cross sectional views of pulley assemblies similar to that shown in FIG. 7 except with each showing a different cross sectional configuration of belt groove on the outer periphery of the pulley.

### DETAILED DESCRIPTION OF THE INVENTION

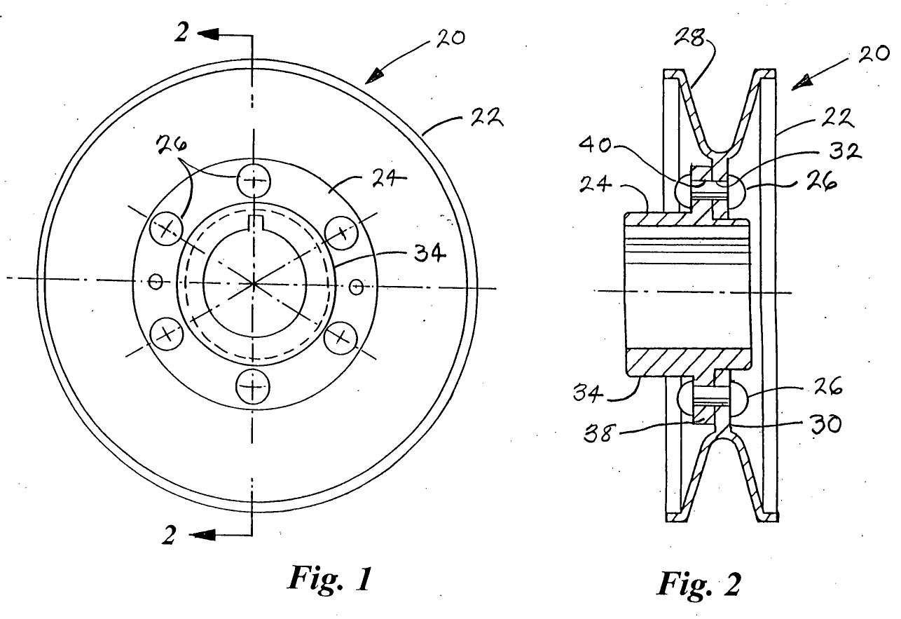

Referring to the drawings and in particular to FIGS. 1 and 2, a pulley assembly indicated by the numeral 20 has a pulley 22 and a hub 24 fastened together by rivets 26.

The pulley has a belt groove 28 extending around the outer periphery thereof and an annular web portion 30 extending radially inwardly from the belt groove 28. The web portion 30 has a plurality of space apart holes 32 located around the web and extending transversely therethrough.

The hub 24 has an annular body portion 34 and an annular extension flange 38 projecting radially outwardly to overlay and lie adjacent the web 30 when the hub and pulley are assembled together. The flange 38 has a plurality of holes 40 which are spaced to correspond to the holes 32 in the pulley web 30 to permit the rivets 26 to pass through the flange 38 and web 30 and fasten together the pulley and hub.

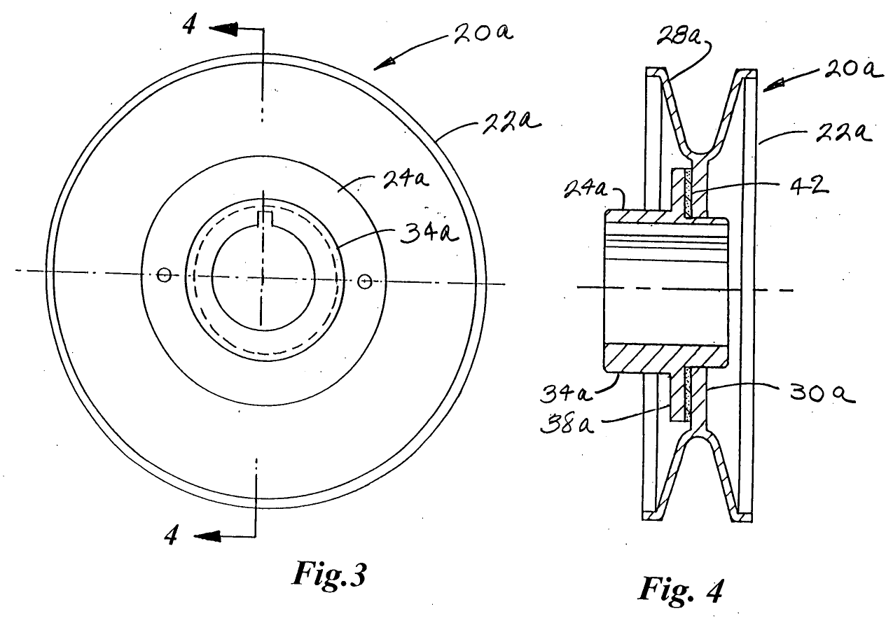

Referring now to FIGS. 3 and 4, a pulley assembly 20a is similar to the pulley assembly 20 except that instead of having pulley 22a and hub 24a fastened together by rivets they are fastened together by an adhesive layer 42 between adjacent surfaces of a web 30a and a hub extension flange 38a. The adhesive layer can be any suitable adhesive which bonds to metal and withstands the temperatures which will be encountered by the pulley assembly when in use.

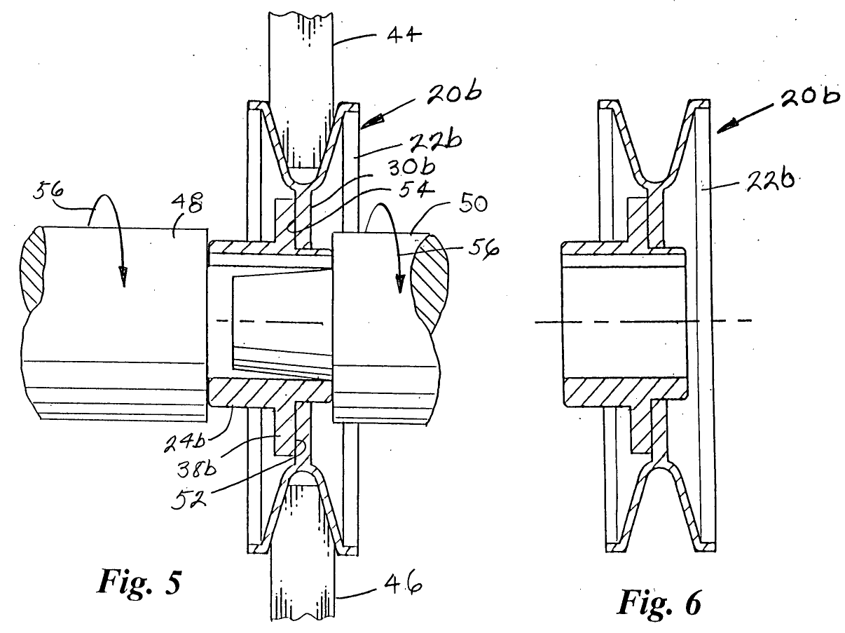

Referring to FIGS. 5 and 6, a pulley assembly 20b is similar to the pulley assembly 20a except that a pulley 22b is attached to a hub 24b by friction welding by the apparatus shown in FIG. 5. A pair of jaws 44 and 46 are moved radially inwardly to grip the pulley 22b and hold it in a fixed position. A pair of jaws 48 and 50 grip the ends of the hub 24b and moves it axially toward the pulley 22b until it contacts the pulley. The hub 24b has an extension flange 38b which has a vertical surface 52. A web 30b has a vertical surface 54 which is contacted the surface 52 when the hub 24b is moved against the pulley 22b. As the surfaces 52 and 54 come into contact, the jaws 48 and 50 rotate the hub 24b in the direction shown by the arrows 56 generating heat between the surfaces 52 and 54 and causing the metal to melt sufficiently on the surface to weld together the web 30b and the flange 38b so that when rotation is stopped and the surfaces cool the are welded together due to the heat generated by the friction of the parts.

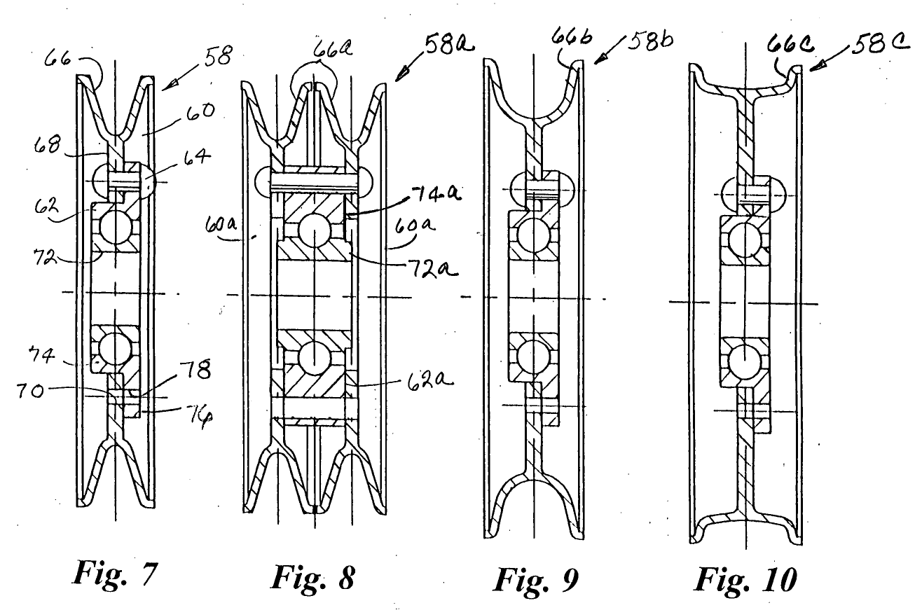

Referring now to FIG. 7, a pulley assembly 58 has a pulley 60 and a bearing 62 attached thereto by rivets 64. The pulley 60 is similar to the pulley 22 in FIG. 1 except that instead of being attached to a hub it is attached to the bearing 62. The pulley 60 has a belt groove 66 extending around the outer periphery thereof and an annular web portion 68 extending radially inwardly from the belt groove 66. The web portion 30 has a plurality of spaced apart holes 70 located around the web and extending transversely therethrough.

The bearing 62 has an inner bearing race 72 and an outer bearing race 74 which has an annular extension flange 76 projecting radially outwardly to overlap and lie adjacent the web 68 when the hub and pulley are assembled together. The flange 76 has a plurality of holes 78 which are spaced to correspond to the holes 70 in the pulley web 68 to permit the rivets 64 to pass through the flange 76 and web 68 and fasten together the pulley and hub.

FIG. 8 shows a pulley assembly 58a which is similar to the assembly 58 except that instead of having a single pulley containing a bearing two pulleys 60a are mounted on each side of a bearing 62a having an inner race 72a and an outer race 74a. The outer race 74a extends radially outwardly a sufficient distance to permit a plurality of rivets 64 to pass through matching hole in the outer race 74a and the web 68a of both of the pulleys 60a and fasten them to the bearing 62a.

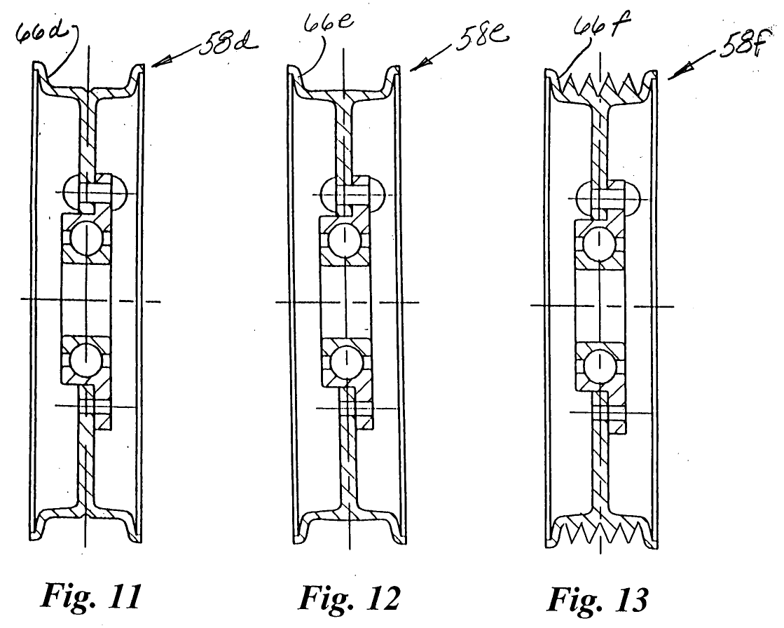

FIGS. 9 through 13 are substantially identical to the pulley assembly 58 in FIG. 7 and all the parts are similar except that each of the FIGS. 9 through 13 shows a belt groove having a different cross sectional contour. In the interest of simplicity all the individual parts being similar to the parts in FIG. 7 will not be described individually but will be referred to as pulley assemblies 58b, 58c, 58d, 58e, and 58f having respectively belt grooves 66b, 66c, 66d, 66e, and 66f.

It may be seen that regardless of all these variations of belt grooves the pulleys are attached to the bearing with rivets in the same manner as that shown with the bearing assembly 58 in FIG. 7.

It should be recognized that all these variations of pulley assemblies can also be attached to each other with an adhesive layer similar to that shown in the pulley assembly 20a in FIGS. 3 and 4.

These and other variations in pulley configurations can utilize the same fastening means shown herein without departing from the scope of the invention.

What is claimed is:

1. A pulley assembly having a pulley and a central shaft engaging member comprising:
at least one pulley having an outer peripheral rim and an annular web portion extending radially inwardly therefrom and having a plurality of holes extending transversely therethrough;
a central shaft engaging member having a radially outwardly extending annular extension with a plurality of holes extending transversely therethrough spaced to be in alignment with the holes in the web portion when the shaft engaging member is positioned within the center of the pulley; and
a fastening member extending through each hole in the annular web and radially outwardly extending annular extension to securely fasten the shaft engaging member to each pulley in the assembly.

2. A pulley assembly as claimed in claim 1, wherein the shaft engaging member is a bearing.

3. A pulley assembly as claimed in claim 2, wherein the bearing has an inner race, an outer race with a plurality of round bearing members therebetween and wherein the radially outwardly extending annular extension extends radially outwardly from the outer race of the bearing.

4. A pulley assembly as claimed in claim 1, wherein the shaft engaging member is a hub.

5. A pulley assembly as claimed in claim 2, wherein the radially outwardly extending extension extends radially outwardly from the outer periphery of the hub.

6. A pulley assembly as claimed in claim 1, wherein the fastening members are rivets.

7. A pulley assembly as claimed in claim 1, wherein the pulley is constructed from a flat disk in which the outer periphery is split and swaged while rotating the disk to form the outer peripheral rim having a cross sectional configuration to correspond to a certain designated belt cross section.

8. A pulley assembly as claimed in claim 7, wherein the outer peripheral rim has a substantially “V” shaped cross section.

9. A pulley assembly as claimed in claim 7, wherein the outer peripheral rim has a substantially “U” shaped cross section.

10. A pulley assembly as claimed in claim 7, wherein the outer peripheral rim has a substantially flat bottom shaped cross section.

11. A pulley assembly as claimed in claim 7, wherein the outer peripheral rim has a substantially concave shaped bottom cross section.

12. A pulley assembly as claimed in claim 7, wherein the outer peripheral rim has a substantially convex shaped bottom cross section.

13. A pulley assembly as claimed in claim 7, wherein the outer peripheral rim has a substantially poly “V” cross section.

14. A pulley assembly as claimed in claim 1 wherein two pulleys are mounted on opposite sides of the radially outwardly extending annular extension of the central shaft engaging members and each fastening member extends through aligned holes in the annular extension and through the web of both of the pulleys to fasten both pulleys to the annular extension.

15. A pulley assembly having a pulley and a central shaft engaging member comprising:
at least one pulley having an outer peripheral rim and an annular web portion extending radially inwardly therefrom and having a plurality of holes extending transversely therethrough;
a bearing having a radially outwardly extending annular extension with a plurality of holes extending transversely therethrough spaced to be in alignment with the holes in the web portion when the shaft engaging member is positioned within the center of the pulley; and
a fastening member extending through each hole in the annular web and radially outwardly extending annular extension to securely fasten the shaft engaging member to each pulley in the assembly.

16. A pulley assembly as claimed in claim 15, wherein the pulley is constructed from a flat disk in which the outer periphery is split and swaged while rotating the disk to form the outer peripheral rim having a cross sectional configuration to correspond to a certain designated belt cross section.

17. A pulley assembly as claimed in claim 16 wherein the fastening members are rivets.

18. A pulley assembly as claimed in claim 16 wherein the fastening members are screws.

19. A pulley assembly having a pulley and a central shaft engaging member comprising:
at least one pulley having an outer peripheral rim and an annular web portion extending radially inwardly therefrom and having a plurality of holes extending transversely therethrough;
a hub having a radially outwardly extending annular extension with a plurality of holes extending transversely therethrough spaced to be in alignment with the holes in the web portion when the shaft engaging member is positioned within the center of the pulley; and
a fastening member extending through each hole in the annular web and radially outwardly extending annular extension to securely fasten the shaft engaging member to each pulley in the assembly.

20. A pulley assembly as claimed in claim 19, wherein the pulley is constructed from a flat disk in which the outer periphery is split and swaged while rotating the disk to form the outer peripheral rim having a cross sectional configuration to correspond to a certain designated belt cross section.

21. A pulley assembly as claimed in claim 20, wherein the fastening members are rivets.

22. A pulley assembly as claimed in claim 20, wherein the fastening members are screws.

23. A pulley assembly having a pulley and a central shaft engaging member comprising:
at least one pulley having an outer peripheral rim and an annular web portion extending radially inwardly therefrom;
a central shaft engaging member having a radially outwardly extending annular extension
the annular web portion of each pulley and the outwardly extending annular extension of the central shaft engaging member each having an annular radially extending surface in intimate contact with each other when the shaft engaging member is positioned within the center of the pulley; and
a means permanently bonding the surfaces together to securely attach the shaft engaging member to the pulley.

24. The pulley assembly as claimed in claim 23 wherein the means permanently bonding the surfaces together is a layer of adhesive the annular web and radially outwardly extending annular extension to securely fasten the shaft engaging member to each pulley in the assembly.

25. The pulley assembly as claimed in claim 23 wherein the means permanently bonding the surfaces together is a friction weld produced by the steps or rotating at least one of the surfaces against the other at a sufficient speed to cause melting of material on each surface, stopping rotation of any rotating surfaces and allowing the surface to cool causing the liquid to solidify and fuse together.
